(19) United States
(12) Patent Application Publication
(10) Pub. No.: US 2025/0283367 A1
(43) Pub. Date: Sep. 11, 2025

(54) Electrically Operated Flap System With Weather Guard for Electrically Charging and/or Fueling a Vehicle, Electric Charging and/or Fueling Method, and Vehicle

(71) Applicant: BAYERISCHE MOTOREN WERKE AKTIENGESELLSCHAFT, München (DE)

(72) Inventors: Christian DRESCHER, Markt Indersdorf (DE); Martin KAUNZINGER, Muenchen (DE); Thomas ROTH, Eching (DE)

(21) Appl. No.: 18/861,625

(22) PCT Filed: Oct. 13, 2023
(86) PCT No.: PCT/EP2023/078463

§ 371 Date: Oct. 30, 2024

(30) Foreign Application Priority Data
Oct. 27, 2022 (DE) 10 2022 128 435.2

(51) Int. Cl. E05F 15/41; E05F 15/611; E05F 15/75

(52) U.S. Cl. CPC E05F 15/41; E05F 15/611; E05F 15/75; E05Y 2400/31; E05Y 2400/356; E05Y 2400/36; E05Y 2900/534

(57) ABSTRACT

An electrically operated flap system for charging and/or fueling a vehicle, in particular an electric vehicle, includes a connection element for connecting a connection part of a charging and/or fueling station to the vehicle, a pivotal cover flap in order to cover the connection element in a closed position and to release same in an open position, an electric motor for driving the cover flap via a hinge arm, a controller for controlling the electric motor in order to move the cover flap in a closing direction and in an opening direction, and an obstacle detection device in order to ascertain if the cover flap and/or the hinge arm is being driven against the connection part when being moved in the closing direction and is being prevented from moving further. On the basis of the ascertained obstruction by the connection part, the controller produces a counter movement of the cover flap in the opening direction until the cover flap assumes a protective position which lies between the position reached by the cover flap up to the connection part and the open position in order to form a weather guard during a charging and/or fueling process.

### BACKGROUND AND SUMMARY

The invention relates to an electrically operated flap system with weather protection for electrically charging and/or fueling a vehicle. The invention also relates to a method for electrically charging and/or fueling a vehicle comprising an electrically operated flap system, and to a vehicle.

The invention is particularly suitable for use in electrically powered vehicles in which an external electrical energy source, such as a charging station for example, is connected to the vehicle in order to charge it with electricity as an energy source which is stored in an electrical accumulator of the vehicle.

However, the invention can also be used in vehicles with internal combustion engines in which a fuel as an energy source is supplied to the vehicle at a gas station, for example. The invention can also be used for hybrid vehicles in which an external energy source is connected to the vehicle in order to charge and/or fuel it with electrical energy and/or a fuel.

Flap systems of this kind are also called filling or, respectively, charging flap systems. They generally have a pivotable covering flap or closure flap which is opened for filling the vehicle with an energy source, such as electric current for example, or with some other type of fuel for driving the vehicle motor/engine and is closed again after filling. In the closed state, the covering flap protects a connection element which is situated behind it and serves, for example, for a charging plug of an electric charging station and/or a fuel line of a fuel pump to be connected to it. The connection element can be, for example, a charging socket which is held in a holding element or charging pot or charging recess of the flap system.

One problem faced here is that the connection element or the charging socket and the charging recess are not protected against weathering influences when the covering flap is open. Rain, moisture, snow and leaves can therefore reach the connection element or the charging socket and enter the charging recess during charging or fueling of the vehicle. Particularly when used in winter, snow can collect in the charging recess and cover the connection element and a charging plug connected to it during charging of the vehicle. Furthermore, there are a large number of different charging systems, country-specific variants, positions in the charging pot, variants of charging plugs or filling openings for gasoline or diesel, and filling nozzles.

The object of the invention is to provide a flap system or filling flap system which provides weather protection for the connection element during charging or fueling of a vehicle even for a variety of charging systems, and in particular protects the charging socket and the charging recess or else a fuel filling opening against weathering influences.

In order to achieve the object, the invention provides an electrically operated flap system with weather protection for electrically charging and/or fueling a vehicle, in particular an electric vehicle, comprising a connection element for connecting a connecting part of a charging and/or gas station to the vehicle, a pivotable covering flap in order to cover the connection element in a closed position and to uncover the connection element in an open position in order to connect the connecting part to it; an electric motor, which is coupled to the covering flap via a hinge arm, for driving the covering flap; a controller for controlling the electric motor in order to move the covering flap in the closing direction and in the opening direction; and an obstacle identification device in order to establish if the covering flap and/or the hinge arm are/is driven against the connected connecting part as they move/it moves in the closing direction and thus are/is prevented from moving further in the closing direction; wherein the controller is designed in such a way that, on account of the prevention of further movement by the connecting part being identified, it causes an opposite movement of the covering flap in the opening direction until the covering flap assumes a protective position which lies between the position reached by the covering flap up to the connecting part and the open position in order to provide weather protection during charging and/or fueling.

The invention ensures the best possible weather protection irrespective of different country-specific variants, charging systems, charging plugs or filling nozzles. This is possible particularly since a permanently stored position of the covering flap is not required during charging or fueling.

The controller is preferably designed in such a way that it initiates the movement of the covering flap in the closing direction with a reduced movement speed.

The controller is preferably designed in such a way that it initiates the movement of the covering flap in the closing direction with a reduced drive torque.

The controller is preferably designed in such a way that it initiates the opposite movement of the covering flap in the opening direction by a predefined amount.

The obstacle identification device is preferably designed to detect an increase in the torque of the electric motor.

The controller is advantageously designed in such a way that it causes the covering flap to move from the protective position to the open position when an authenticated user approaches.

The flap system preferably comprises a sensor element which is designed to detect manual actuation of the covering flap and/or the performance of a gesture in order to cause the movement of the covering flap from the protective position to the open position.

One aspect of the invention provides a method for electrically charging and/or fueling a vehicle comprising an electrically operated flap system which is fixed in a bodyshell element of the vehicle, wherein the flap system comprises a connection element for connecting a connecting part of a charging and/or gas station and a pivotable covering flap, which is connected to a hinge arm, for covering the connection element in a closed position and for uncovering the connection element in an open position, and wherein the method comprises the following steps:
(A) moving the pivotable covering flap of the flap system by way of an electric motor, which is coupled to the hinge arm, from a closed position in an opening direction until the covering flap reaches an open position;
(B) connecting the connecting part to the connection element while the covering flap is in the open position;
(C) moving the covering flap by the electric motor, which is coupled to the hinge arm, in a closing direction until an obstacle identification device establishes that the covering flap and/or the hinge arm have/has been driven against the connected connecting part and thus are/is prevented from moving further;
(D) once again moving the covering flap in the opening direction until it assumes a protective position which lies between the position reached by the covering flap up to the obstacle and the open position in order to form weather protection for the connection element during charging and/or fueling; and
(E) electrically charging and/or fueling the vehicle while the covering flap is in the protective position.

The covering flap is preferably moved out of the position reached by the covering flap up to the connecting part in the opening direction by a predefined amount in order to reach the protective position.

The covering flap is advantageously automatically moved from the protective position to the open position when an authenticated user approaches.

Manual actuation of the covering flap and/or of the hinge arm and/or the performance of a gesture is preferably identified, as a result of which the movement of the covering flap from the protective position to the open position is triggered.

A further aspect of the invention provides a vehicle, in particular an electric vehicle, which comprises a flap system according to the invention.

Advantages, features and details which are described in conjunction with the flap system also apply to the described method, and vice versa.

Features which are described or shown in different embodiments and exemplary embodiments should be understood such that they can be combined with each other, unless described otherwise, or any such combination is not obviously impossible.

Preferred exemplary embodiments of the invention will be explained in more detail below with reference to drawings.

### BRIEF DESCRIPTION OF THE DRAWINGS

FIG. 1 is a schematic side view of a flap system according to a preferred embodiment of the invention, with a connected charging plug, wherein the covering flap is in the protective position for protecting against weathering influences during electrical charging of the vehicle;

FIG. 2 shows the flap system shown in FIG. 1 in a closed state;

FIG. 3 shows a flap system according to a further preferred embodiment of the invention, the flap system being in the form of a filling flap system, in the closed state;

FIG. 4 shows the flap system shown in FIGS. 1 to 3 with the flap fully

opened;

FIG. 5 shows the flap system shown in FIGS. 1 to 3 in a state in which the flap is moved toward the charging plug or toward the filling nozzle from above;

FIG. 6 shows the flap system shown in FIGS. 1 to 3 in its protective position while it is being manually actuated in a first way for initiating the opening process; and

FIG. 7 shows the flap system shown in FIGS. 1 to 3 in its protective position while it is being manually actuated in a second way for initiating an opening process.

In the figures, elements which are identical or correspond to each other are in each case identified with the same reference signs and are therefore not described again unless this appears to be expedient. The disclosures contained in the entire description are correspondingly applicable to parts having identical reference signs or identical component designations.

### DETAILED DESCRIPTION OF THE DRAWINGS

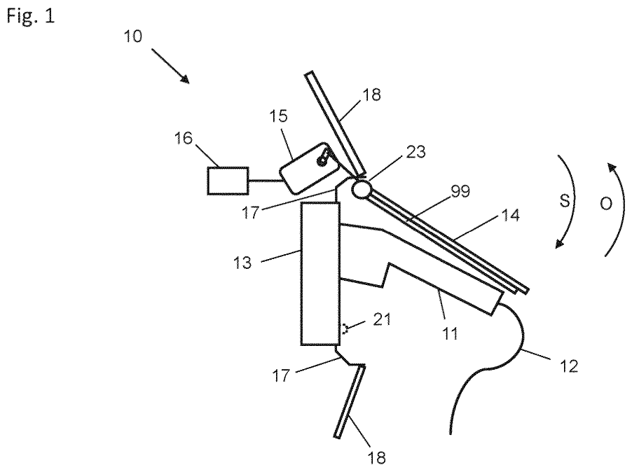

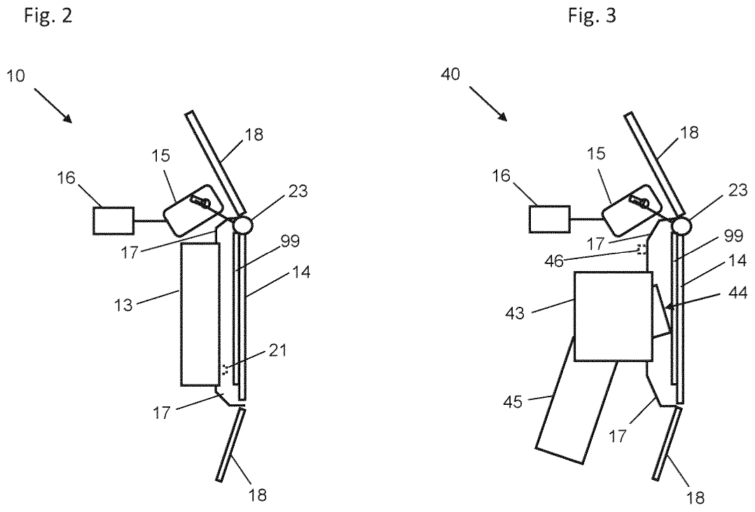

FIGS. 1 and 2 show an electrically operated flap system 10 according to a first preferred embodiment of the invention which is in the form of a charging flap system. FIG. 1 shows the flap system 10 with a connecting part 11 in the form of a charging plug connected to it during a charging process, while FIG. 2 shows the flap system 10 in the closed state.

As illustrated in FIG. 1, the charging plug 11 is connected to an external electrical charging station, not illustrated in the figure, via a charging cable 12. The flap system 10 comprises a connection element 13 which, in this embodiment, is in the form of a charging socket and serves for connection of the charging plug 11, which forms a connecting part. A pivotable covering flap in the form of a charging flap 14 is provided in order to cover the charging socket or the connection element 13 in a closed position and to uncover it in an open position, so that the connecting part or the charging plug 11 can be connected to the connection element or the charging socket 13. FIG. 1 shows the covering flap 14 in a partially opened state in which it forms weather protection for the charging plug 11 situated beneath it and the charging socket 13, that is to say assumes a protective position.

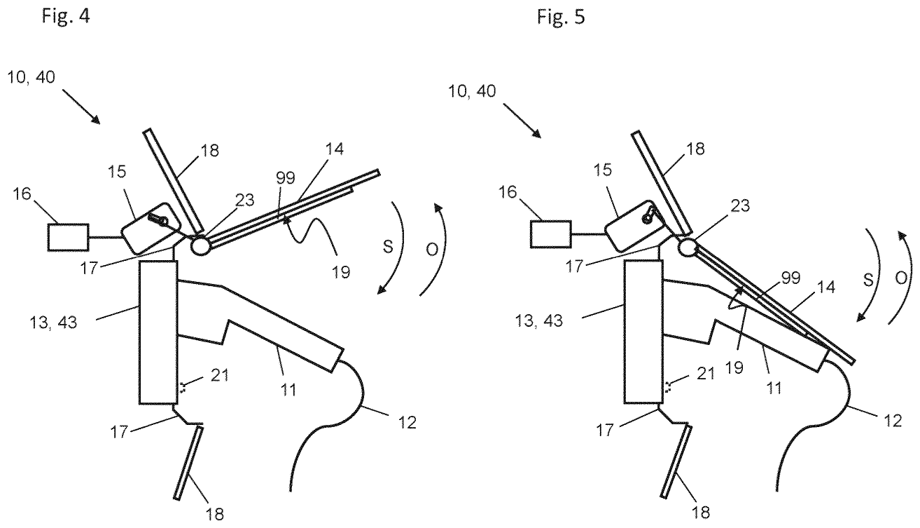

The covering flap 14 is coupled via a movable or pivotable hinge arm 99 to an electric motor 15, which is designed to drive the covering flap 14 in order to move it back and forth between its open position (see FIG. 4) and its closed position (see FIG. 2). In the closed position, the charging socket 13 is completely covered by the covering flap 14 and is closed off to the outside.

The hinge arm 99 is in the form of a receiving plate in order to fix the flap 14 to it.

A controller 16 serves to control the electric motor 15 in order to move the covering flap 14 in the closing direction S and in the opening direction O.

An obstacle identification device, not shown in the figure, which is integrated into the electric motor 15 for example, is provided in order to establish if the covering flap 14 and/or the hinge arm 99 are/is driven against an obstacle, which is formed by the charging plug 11 plugged into the connection element 13, as they move/it moves in the closing direction S. In the position reached by the covering flap up to the obstacle or the charging plug 11, the bottom side 19 of the covering flap 14 or of the hinge arm 99 touches the charging plug 11 (see FIG. 5).

The hinge arm 99 can, just like the covering flap 14, form a meeting face for the obstacle.

The obstacle identification device is designed in such a way that it detects an increase in the torque of the electric motor 15 using a torque sensor as the covering flap 14 moves in the closing direction S. As soon as an increase in the torque and therefore an obstacle are identified, the closing process is terminated and the opposite movement in the opening direction O is initiated by the controller 16.

That is to say, the controller 16 is designed in such a way that, on account of obstacle being identified, it causes an opposite movement of the covering flap 14 in the opening direction O, which is directed opposite to the closing direction S, until the covering flap 14 assumes a protective position, which lies between the position reached by the covering flap up to the obstacle and the open position. As soon as the covering flap 14 assumes its protective position, it provides weather protection during charging of the vehicle (see FIG. 1).

The charging socket 13 is connected to the shell of the vehicle and is not illustrated any further in the figures. A holding element 17, which is in the form of a charging pot or a charging recess, adjoins the charging socket 13. The holding element or the charging pot 17 is fixed in a bodyshell element 18 of the vehicle which forms the outer paneling of the vehicle. In particular, fixing is formed by clipping.

The controller 16 is designed, in particular, in such a way that the covering flap 14 is driven with a reduced movement speed and a reduced drive torque during the closing process, that is to say as it moves in the closing direction S. The flap system 10 will, with a movement profile requested for it, perform the closing process until the covering flap 14 is driven against the obstacle present and formed by the charging plug 11 plugged into the connection element 13 during charging of the vehicle, or by a filling nozzle or the like in the case of a filling flap system.

Since the flap 14 is moved in the closing direction S until it reaches the obstacle or the plug 11 or some other connected connecting part, and the opposite movement of the covering flap 14 in the opening direction O then takes place in order to form a small spacing between the covering flap 14 or the hinge arm 99 and the charging plug 11 during the charging process, optimum weather protection against rain, snow, falling leaves etc. is also achieved with differently shaped charging parts or connecting parts 11 which are connected to the connection element 13.

In addition, the covering flap 14 does not rest on the charging plug 11 during the charging process, this providing additional protection against damage to the bottom side 19 of the covering flap 14 or the hinge arm 99.

A charging termination button 21 is provided on the charging socket 13 and is accessible from the outside when the charging flap 14 is open. The charging termination button 21 initiates termination of the charging process when it is actuated by a user.

FIG. 3 shows a flap system 40 according to a second preferred embodiment of the invention in the closed state. In this example, the flap system 40 is in the form of a filling flap system which serves to supply fuel, such as gasoline or diesel in particular, to a vehicle.

In this case, the connection element, instead of being in the form of a charging socket, is in the form of a filler apparatus 43 which comprises a filler opening 44 which is designed to receive or be connected to a connecting part 11 in the form of a fuel outlet line, in particular a filling nozzle. The filler apparatus 43 is connected to a fuel tank in the interior of the vehicle via a fuel line 45.

In this embodiment, the covering flap 14 is formed by a filling flap. The holding element 17 is in the form of a pot or a recess which surrounds the connection element 43, wherein the holding element 17 is fixed to the outer paneling 18, preferably by being clipped.

An opening request identification device 46 is designed to identify a request by a user to open the filling flap 14, for example by way of a signal, a gesture or the like, and then to initiate opening of the filling flap 14.

In respect of all further features and details, the filling flap system 40 is designed in the same way as the above-described charging flap system 10 according to the first preferred embodiment, to which reference is hereby expressly made in order to avoid repetition.

A preferred exemplary embodiment of the method according to the invention will be described below. The method can be carried out in the same way both with the charging flap system 10 and with the filling flap system 40. The figures, to which reference is made for describing the method, relate to both types of flap system.

The covering flap 14 is initially in the closed state (see FIGS. 2 and 3).

Step A: In order to charge or fuel the vehicle, the covering flap or flap 14 is initially fully opened with the aid of the motor 15. In the process, the pivotable covering flap 14 or the hinge arm 99 of the flap system 10, 40 connected to the charging covering flap is moved by the electric motor 15 from its closed position in the opening direction O until the covering flap 14 reaches an open position (see FIG. 4).

Step B: Once the covering flap 14 has reached its open position, a connecting part 11, in particular a charging plug or a filling nozzle, is connected to or plugged onto the charging socket 13 or the filler apparatus 43, as shown in FIG. 4.

According to subsequent steps C and D, the flap 14 is then moved to a variable closed position in accordance with a corresponding request. For this purpose, a movement command for the variable closed position is made by the controller 16, which is in the form of a function master.

Step C: In order to move to the variable closed position, the covering flap 14 or the hinge arm 99 connected to it is initially moved by the electric motor 15 in the closing direction S until the obstacle identification device establishes that the covering flap 14 and/or the hinge arm 99 have/has been driven against the connected connecting part 11 (see FIG. 5).

The movement, initiated by the controller 16, of the covering flap 14 in the closing direction S is performed with a reduced drive torque and with a reduced movement speed. The obstacle is identified by the increase in the torque on the motor 15 when the obstacle is reached, this obstacle being formed by the connected charging plug or the filling nozzle. The motor then stops the movement.

Step D: The covering flap 14 is then once again moved in the opening direction O until it assumes a protective position which lies between the position reached by the covering flap up to the obstacle 11 and the open position. For this purpose, brief reversing is performed by the flap system 10 or 40 in the direction for opening or in the opening direction O, that is to say the flap 14 or the hinge arm 99 moves away from the charging plug again and forms a small spacing from it. In the process, the controller 16 initiates an opposite movement of the covering flap 14 in the opening direction O by a predefined amount or reversing angle. This preset angle can be 3 to 40 degrees for example. In particular, an opening angle of approximately 10 to 15 degrees is preferred.

The opposite movement of the covering flap in the opening direction O can also be initiated through a variable reversing angle, which is dependent on an identified obstacle position.

The flap 14 or the hinge arm 99 is now in the variable closed position, which depends on the shape of the respectively used charging plug 11 or the filling nozzle (see FIG. 1). In the variable closed position, the flap 14 is in a protective position, in which it covers the connected connecting part 11 in an optimum manner and thus provides protection against rain, snow, hail, falling leaves and the like.

In this way, the flap 14 provides weather protection both for the connection element, that is to say for the charging socket 13 or the filler apparatus 43, and for the connecting part 11 during charging and/or fueling of the vehicle.

Step E: Charging and/or fueling of the vehicle now takes place, while the covering flap 14 is in the protective position.

In order to open the flap system 10 or 40 after termination of the charging or filling process from the variable closed position, the situation of a vehicle user with valid authentication approaching the vehicle is detected. The function master or the controller 16 then outputs a movement command, which causes the flap 14 to be opened by the electric motor 15 (see FIG. 4). In the reached open position, the charging plug 11 or the filling nozzle can be pulled out of the flap system 10, 40 and separated from it.

The flap 14 then closes, for example, automatically or by actuation of a corresponding button.

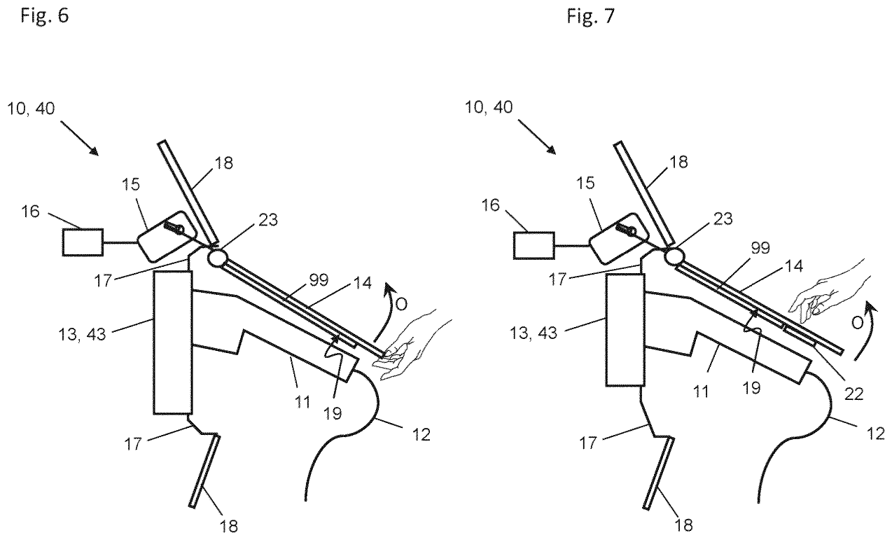

In particular, as shown in FIG. 6, opening of the flap 14 can be triggered manually by an authenticated user by means of a tap-to-run function. For this purpose, the user places one finger beneath the edge of the hinge arm 99 or the flap 14, which is in the protective position according to FIG. 1, and pulls on the bottom side 19 in the opening direction O of the flap 14 or the hinge arm 99. A movement identification means in the actuator or in the motor 15 detects a rotational movement, caused by the exerted pulling, of the pivotable flap 14 about its pivot or rotation axis 23. The flap 14 is then moved to the open position or to the opened position by means of the tap-to-run function, as is shown in FIG. 4, in order to be able to withdraw the charging plug 11 or the filling nozzle 11.

In addition, as shown in FIG. 7, the flap system 10 or 40 can be opened from the variable closed position by activating an optional sensor 22, which is in the form of a touch sensor in particular. The sensor 22 is preferably arranged on the bottom side 19 of the flap 14, that is to say on its inner or rear side.

For this purpose, the vehicle is initially woken up when a user with valid authentication approaches the vehicle. When the flap 14 is touched in a sensitive position in the region of the sensor 22, for example by being tapped or touched, the sensor 22 sends an opening request signal to the function master or to the controller 16, as a result of which the motor 15 is initiated to move the flap 14 in the opening direction O until the flap 14 is fully opened. The charging plug 11 or the filling nozzle 11 can then be withdrawn (see FIG. 2).

The sensor 22 can be designed to detect manual actuation of the covering flap 14 and/or to detect performance of a gesture.

### LIST OF REFERENCE SIGNS

10 Flap system or charging flap system
11 Connecting part/charging plug/filling nozzle
12 Charging cable
13 Connection element/charging socket
14 Covering flap
15 Electric motor
16 Controller
17 Holding element or charging pot
18 Bodyshell element/outer paneling
19 Bottom side of the covering flap
21 Charging termination button
22 Sensor
23 Rotation axis
40 Flap system or filling flap system
43 Filler apparatus
44 Filler opening
45 Fuel line
46 Opening request identification device
99 Hinge arm/receiving plate
O Opening direction
S Closing direction

1.-10. (canceled)

11. An electrically operated flap system for electrically charging and/or for fueling a vehicle, comprising:
a connection element for connecting a connecting part of a charging and/or gas station to the vehicle;
a pivotable covering flap configured to cover the connection element in a closed position and to uncover the connection element in an open position in order to connect the connecting part to the connecting element;
an electric motor, which is coupled to the covering flap via a hinge arm, for driving the covering flap;
a controller for controlling the electric motor in order to move the covering flap in a closing direction and in an opening direction; and
an obstacle identification device that establishes whether the covering flap and/or the hinge arm are/is driven against the connecting part as they move/it moves in the closing direction and thus are/is prevented from moving further in the closing direction,
wherein the controller is configured such that, on account of identifying that further movement by the connecting part is prevented, the control device causes an opposite movement of the covering flap in the opening direction until the covering flap assumes a protective position which lies between the position reached by the covering flap up to the connecting part and the open position in order to provide weather protection during charging and/or fueling.

12. The flap system according to claim 11, wherein the control device is further configured to:
(i) initiate the movement of the covering flap in the closing direction with a reduced movement speed; and/or
(ii) initiate the movement of the covering flap in the closing direction with a reduced drive torque; and/or
(iii) initiate the opposite movement of the covering flap in the opening direction by a predefined amount; and/or
(iv) initiate the opposite movement of the covering flap in the opening direction through a variable reversing angle, which is dependent on an identified obstacle position.

13. The flap system according to claim 11, wherein
the obstacle identification device is configured to detect an increase in torque of the electric motor.

14. The flap system according to claim 11, wherein the control device is further configured to:
cause the covering flap to move from the protective position to the open position when an authenticated user approaches.

15. The flap system according to claim 11, further comprising:
a sensor which is configured to detect manual actuation of the covering flap and/or a performance of a gesture, in order to cause the movement of the covering flap from the protective position to the open position.

16. A method for electrically charging and/or fueling a vehicle comprising an electrically operated flap system which is fixed in a bodyshell of the vehicle, wherein the flap system comprises a connection element for connecting a connecting part of a charging and/or gas station and a pivotable covering flap, which is connected to a hinge arm, for covering the connection element in a closed position and for uncovering the connection element in an open position,
wherein the method comprises the steps of:
(A) moving the pivotable covering flap of the flap system via an electric motor, which is coupled to the hinge arm, from a closed position in an opening direction until the covering flap reaches an open position;
(B) connecting the connecting part to the connection element while the covering flap is in the open position;
(C) moving the covering flap by the electric motor, which is coupled to the hinge arm, in a closing direction until an obstacle identification device establishes that the covering flap and/or the hinge arm have/has been driven against the connected connecting part and thus are/is prevented from moving further;
(D) once again moving the covering flap in the opening direction until the covering flap assumes a protective position which lies between the position reached by the covering flap up to the connecting part and the open position, in order to provide weather protection for the connection element during charging and/or fueling; and
(E) charging and/or fueling the vehicle while the covering flap is in the protective position.

17. The method according to claim 16, wherein
the covering flap is moved out of the position reached by the covering flap up to the connecting part in the opening direction by a predefined amount in order to reach the protective position.

18. The method according to claim 16, wherein
the covering flap is automatically moved from the protective position to the open position when an authenticated user approaches.

19. The method according to claim 16, wherein
manual actuation of the covering flap and/or of the hinge arm and/or the performance of a gesture is identified and triggers the movement of the covering flap from the protective position to the to the open position.

20. A vehicle comprising a flap system according to claim 11.

21. The vehicle according to claim 20, wherein the vehicle is an electric vehicle.
